(19) United States
(12) Patent Application Publication
(10) Pub. No.: US 2026/0309916 A1
(43) Pub. Date: Oct. 8, 2026

(54) LOW-LOSS PLASMONIC DEVICE AND METHOD FOR MANUFACTURING THE SAME

(71) Applicant: Polariton Technologies AG, Adliswil (CH)

(72) Inventors: Nicholas Alexander GÜSKEN, Menlo Park, CA (US); Florin PÜNTENER, Zürich (CH); Wolfgang HENI, Zürich (CH)

(73) Assignee: Polariton Technologies AG, Adliswil (CH)

(21) Appl. No.: 18/996,709

(22) PCT Filed: Sep. 12, 2022
(86) PCT No.: PCT/EP2022/075251

§ 371 Date: Jan. 17, 2025

(51) Int. Cl. G02B 6/122; G02B 6/132; G02F 1/035; G02F 1/065

(52) U.S. Cl. CPC G02B 6/1226; G02B 6/132; G02F 1/035; G02F 1/065; G02F 2201/07; G02F 2201/501

(57) ABSTRACT

The plasmonic device comprises a substrate (2), at least two electrically conductive electrodes (4a, 4b) forming a gap (6) between them, and at least one 5 electro-optic dielectric body (8) arranged in the gap (6). The electrodes (4a, 4b) and the dielectric body (8) form a plasmonic waveguide. Further, the device comprises a barrier (10) fully separating the electrodes (4a, 4b) and the dielectric body (8), with the barrier (10) being of a material different from the electrodes (4a, 4b) and the dielectric body (8). The barrier (10) may be formed of one or more cover layer (10a, 10 10b). In particular, one of the cover layers may be a metal, e.g. gold, while the other is a dielectric.

### TECHNICAL FIELD

The invention relates to a plasmonic device, to a method for manufacturing a plasmonic device.

### BACKGROUND ART

Plasmonic devices are devices having plasmonic waveguides. Such devices allow to confine guided light to a small volume of space. This strong confinement tends to enhance nonlinear interactions between the light and the solid of the plasmonic waveguide.

Devices of this type are e.g. used for electro-optic light modulators or devices converting optical signals into electric signals, such as e.g. described in WO 2021/063548, WO 2021/175590, and WO 2022/043166.

Such devices are typically manufactured by using micro-structuring techniques, e.g. as used in semiconductor manufacturing.

This type of devices typically comprise an electro-optic dielectric body between at least two electrically conductive electrodes. The light is guided along the dielectric body and the surfaces of the electrodes, i.e. the electrodes and the dielectric body form a plasmonic waveguide.

Choosing suitable materials for such a device can be a challenge because numerous criteria need to be met at the same time, such as low optical loss, chemical and optical stability, and good electro-optic properties, all of which can affect the performance of the device.

### DISCLOSURE OF THE INVENTION

The problem to be solved by the present invention is to provide a device and method of this type that provide good performance.

This problem is solved by the device and method of the independent claims.

Accordingly, the plasmonic device comprises at least the following elements:
A substrate: This is the part that the following components are arranged on.
At least two electrically conductive electrodes: These electrodes can be used to apply an electrical field and/or to detect a voltage. They form a gap between them, i.e. they are not electrically interconnected.
At least one dielectric body arranged in the gap: At least one of the electrodes and the dielectric body form the plasmonic waveguide.
A barrier fully separating the electrodes and the dielectric body: This barrier is of a material different from the electrodes and the dielectric body. It fully separates the electrodes and the dielectric body in the sense that it extends along all the interface region between the two parts such that the dielectric body is not in direct contact with the electrodes.

Providing such a barrier allows a more flexible selection of the materials for the electrodes and the dielectric body. In particular, and as shown in the examples that follow, the barrier allows to reduce undesired interactions between the electrodes and the dielectric body.

Advantageously, the electrodes are of copper or silver, in particular silver. In this context, a material is considered to be of e.g. silver if at least 50%, in particular at least 80%, in particular at least 95%, of its mass is silver. Silver is particularly advantageous in that it has low optical loss in a wide spectral range, in particular in the near infrared. On the other hand, it has poor compatibility with many dielectric, in particular electro-optic, materials and is prone to oxidation, but the barrier allows to separate the silver from the dielectric material, thereby reducing incompatibilities and/or oxidation.

In yet another advantageous embodiment, the dielectric material comprises an electro-optic material, which allows to exploit the device for electro-optic effects.

In particular, the electro-optic dielectric body may comprise an electro-optic organic material, in particular by at least 10 weight percent, in particular at least 50 weight percent. Many such organic materials are known to exhibit strong electro-optic effects, but they tend to be chemically incompatible with numerous electrode materials. For example, a dielectric body comprising an organic material tends to be permeable to oxygen and/or water while numerous electrode materials, in particular if they are not noble metals, can be chemically degraded by oxygen and/or water. On the other hand, chemical reactions at the interface between the organic material and the electrodes can degrade the organic material. In this case, again, the barrier allows to separate the metal from the electro-optic material, thereby reducing incompatibilities.

The barrier may be formed by one or more cover layers. Each cover layer extends along at least part of the interface region between the dielectric body and the electrodes.

Advantageously, at least one cover layer fully separates the dielectric body and the electrodes, i.e. it extends along the whole interface region between the dielectric body and the electrodes, which improves the barrier function.

Advantageously, for further design flexibility, the barrier comprises at least two cover layers of different materials. In case, one or both of the following options may apply:
a) At least one cover layer extends only along part of the interface region between the dielectric body and the electrodes: This again improves design flexibility. For example, a cover layer may not extend into the gap to tune the optical properties of the gap, e.g. to reduce absorption in the case of a metal layer.
b) At least two cover layers fully separate the dielectric body and the electrodes, i.e. each of them extends along the whole interface region between the dielectric body and the electrodes. In this case, a tighter barrier may be achieved.

Options a) and b) may be combined by using at least three cover layers.

Advantageously, the barrier comprises at least one dielectric cover layer. Using a dielectric cover layer as compared to a conductive cover layer reduces the losses in the plasmonic waveguide, in particular when being used in combination with a low-loss electrode material, such as silver.

In addition or alternatively thereto, the barrier advantageously comprises at least one conductive cover layer. A conductive cover layer can be used to tune the plasmonic properties of the device and/or it can make it easier to contact the electrodes.

In one embodiment, the combination of a dielectric cover layer and a conductive cover layer may be used. This allows to design the individual cover layers to be thinner while still providing a tight barrier between the dielectric body and the electrodes.

If both a dielectric cover layer and a conductive cover layer is used, the conductive cover layer is advantageously located closer to (i.e. beneath) the dielectric cover layer. Thus, the dielectric cover layer covers the conductive cover layer and can be used to protect the conductive cover layer from humidity, oxygen, and/or other environmental influences. This is particularly advantageous if the conductive cover layer is of silver, copper, or another metal prone to oxidation.

Advantageously, the conductive cover layer is of metal, in particular gold, and directly adjacent (i.e. in direct contact) with the electrode. As described in more detail below, this makes structuring the conductive cover layer easier because metal, in particular gold, typically adheres better to the electrode (e.g. to a metal electrode) than to other parts (e.g. to oxide materials) of the device.

The barrier should be thin in order to maintain a substantial amount of the electric field in the dielectric body. Hence, advantageously, the thickness is less than 20 nm, in particular less than 10 nm. In the most advantageous embodiment, if the barrier is of a single layer, its thickness is less than 5 nm.

In one embodiment, the electrodes and the dielectric body are arranged in a vertical stack on said substrate. In other words, one electrode is arranged below the dielectric body and the other electrode is arranged above the dielectric body.

In another, presently preferred embodiment, the electrodes are arranged side by side on said substrate with the gap located horizontally between them. This simplifies the production of the dielectric body in that it does not have to with-stand the conditions that are used for depositing the upper electrode of a stacked embodiment.

The barrier may completely cover at least one of the electrodes, in particular both of the electrodes, on the sides not facing the substrate, thereby protecting it from environmental influence, in particular from oxidation.

Advantageously, the device comprises at least a first conductive lead located in said substrate and contacting a first one of the electrodes from below. Thus, the electrode can be encapsulated from all sides by the barrier and the substrate, thereby protecting it from environmental influence, in particular oxidation. This is of particular advantage if the first electrode is of a material likely to oxidize, such as silver or copper.

When the electrodes are arranged side by side on the substrate with the gap located horizontally between them, this design can be applied to both electrodes, i.e. the device further comprises a second conductive lead located in the substrate and contacting the second electrode from below.

In the cases of the previous two paragraphs, the “conductive lead” may be a “via” extending through the substrate for being contacted from the bottom side of the substrate. In another embodiment, the “conductive lead” extends along the surface of the substrate but not through the substrate for being contacted at a location horizontally outside the electrode it is connected to.

There may also be a first conductive lead contacting a first one of the electrodes from above, i.e. from the side facing away from the substrate.

In this case, if the device comprises a conductive cover layer, the first conductive lead may contact the first electrode via this conductive cover layer.

The invention also relates to a method for manufacturing such a plasmonic device that comprises the step of depositing the electrodes, the barrier, and the dielectric body on the substrate, i.e. the electrodes, the barrier, and the dielectric body are added onto the substrate by means of suitable deposition processes.

Advantageously, the method comprises the steps of first depositing the electrodes and the barrier and only then the dielectric body. This allows to use deposition processes for the electrodes and barrier—such as processes including elevated temperatures—that may not be compatible with the dielectric body. This is of particular advantage if the dielectric body comprises a temperature-sensitive material, such as an organic material.

In one embodiment, at least one conductive lead is formed prior to depositing the electrodes. In the final device, the conductive lead electrically contacts at least one of the electrodes.

Alternatively or in addition thereto, at least one conductive lead is formed after depositing the electrodes. In the final device, the conductive lead again electrically contacts at least one of the electrodes.

In both cases, the conductive lead is advantageously formed before depositing the dielectric body. Again, this allows to use a deposition process for the conductive lead—such as processes including elevated temperatures—that may not be compatible with the dielectric body, e.g. because the dielectric body comprises a temperature-sensitive material, such as an organic material.

The invention also relates to a device manufactured or manufacturable by this method.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a sectional view of a first embodiment of the device in the region of the gap,

FIG. 2 shows a sectional view of a second embodiment of the device in the region of the gap,

FIG. 3 shows a sectional view of a third embodiment of the device in the region of the gap,

FIG. 4 shows a sectional view of a fourth embodiment of the device in the region of the gap,

FIG. 5 illustrates a first design to contact the electrodes,

FIG. 6 illustrates a second design to contact the electrodes,

FIG. 7 illustrates a third design to contact the electrodes, and

FIG. 8 illustrates a fourth, stacked design to contact the electrodes, and

FIG. 9 shows an example of a device comprising two gaps in different arms of an interferometer.

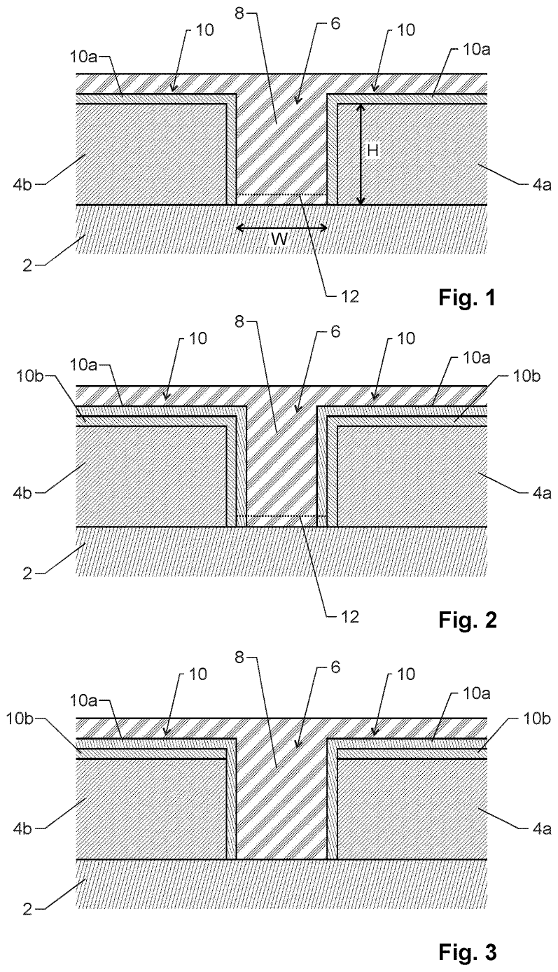

All of FIGS. 1-8 are sectional views perpendicular to the direction of plasmon propagation.

### MODES FOR CARRYING OUT THE INVENTION

### Definitions

A plasmonic waveguide as used herein is adventurously a waveguide having a dielectric body in a gap between at least two electrically conductive electrodes. The electrodes may be of metal or of a strongly doped semiconductor.
An electro-optic dielectric body is a body of a material having a linear or non-linear electro-optic effect (i.e. a refractive index depending the applied electrical field). This type of material can be used for modulators, e.g. as described in the prior art above. It can typically also be used for converting light intensity in the waveguide into a voltage between the electrodes. Advantageously, the material has a linear electro-optic effect (Pockels effect), where the refractive index change has a component that depends linearly on the applied electro-optic field. Such materials exhibit stronger effects at low fields, but they require a non-centric molecular/atomic geometry along the direction of the electric field.
A plasmonic device as used herein is a device comprising at least one plasmonic waveguide.
Light as used herein is understood to encompass infrared, visible, and/or ultraviolet light, advantageously in a vacuum wavelength range between 0.25 μm and 6 μm. Advantageously, the plasmonic device is adapted to process light with a vacuum wavelength between 1 μm and 6 μm where the absorption of silicon is low or 0.9 μm and 5 μm where the absorption of GaAs is low. In particular, the light used for the present device has a wavelength between 1.260 μm and 1.625 μm.
The vertical direction is the direction perpendicular to the substrate of the device, with top and down being defined as the waveguide being located on top of above the substrate of the device. At least some parts of the device are formed by deposition and structuring of layers above the substrate.
Any horizontal direction extends perpendicularly to the vertical direction.
A metal lead or conductive lead is an electrically conductive metal track or conductive track.
The term conductive is used in the sense of electrically conductive.
The term interface region designates the region between the electrodes and the dielectric body. If a cover layer is located in said region, it forms part of the barrier separating the electrodes and the dielectric body but, in particular if the barrier is formed by several cover layers, it is not necessarily in direct contact with both an electrode and the dielectric body.

### First Embodiment

FIG. 1 shows a first embodiment of a plasmonic device having a substrate 2 with two electrodes 4a, 4b arranged thereon. The electrodes 4a, 4b are located, in the shown embodiment, horizontally side by side. They form a gap 6 between them. An electro-optic, dielectric body 8 (i.e. an electrically non-conductive or semi-conductive body) is arranged in gap 6.

As mentioned above, a barrier 10 separates the electrodes 4a, 4b and dielectric body 8. It is of a material different from the electrodes 4a, 4b and dielectric body 8 and extends along the whole interface region between them.

In the shown embodiment, barrier 10 covers the lateral walls of the electrodes 4a, 4b where they face gap 6, but it does not cover the bottom side of gap 6 (i.e. the side of gap 6 facing substrate 2). If barrier 10 is of a non-conductive material, though, it may, as indicated by a dotted line 12, also extend along the bottom side of gap 6.

In the shown embodiment, barrier 10 is formed by a single cover layer 10a that fully separates the electrodes 4a, 4b and dielectric body 8.

Cover layer 10a may be a homogeneous layer, or it may have an in-ternal layer structure due to its surfaces having different properties from its bulk (such as e.g. in nanolaminates).

Details of the used materials and design can be found in the section “general design and materials” below.

### Second Embodiment

The first embodiment has a single cover layer 10a. In contrast to this, the second embodiment of FIG. 2 has a barrier 10 formed by two cover layers 10a, 10b. Both of them extend along the whole interface between the electrodes 4a, 4b and dielectric body 8, i.e. each cover layer 10a, 10b fully separates the electrodes 4a, 4b from dielectric body 8.

As described above, such a design provides further means to optimize the design of the device.

In the shown embodiment, both cover layers 10a, 10b cover the lateral walls of the electrodes 4a, 4b where they face gap 6, i.e. they extend into gap 6, but they do not extend over the bottom side of gap 6. At least some of them may, however, also extend along the bottom side of gap 6 as long as they do not electrically interconnect the electrodes 4a, 4b. Hence, for example, a dielectric cover layer 10a, 10b may extend along the bottom side of gap 6. A conductive cover layer may also extend along the bottom side of gap 6 if there is an additional dielectric cover layer between this conductive cover layer and the electrodes 4a, 4b, with the additional cover layer electrically insulating the conductive cover layer from at least one of the electrodes 4a, 4b.

In this embodiment, outer cover layer 10a is advantageously a dielectric while inner cover layer 10b is a metal, in particular gold.

Again, details of the used materials and design can be found in the section “general design and materials” below.

### Third Embodiment

In the third embodiment of FIG. 3, barrier 10 is again a multi-layer structure, but in this case, at least some of its cover layers 10a, 10b do not extend along the whole interface between dielectric body 8 and the electrodes 4a, 4b. However, together the cover layers 10a, 10b form a barrier extending along the whole of said interface, and together they again separate the electrodes 4a, 4b from dielectric body 8.

In the shown embodiment, one of the cover layers, namely cover layer 10a, fully separates the electrodes 4a, 4b from dielectric body 8, i.e. it extends along all of their interface, while a second cover layer 10b only extends along part of their interface.

In this embodiment, outer cover layer 10a is advantageously a dielectric while cover layer 10b, which only extends along the top side of the electrodes 4a, 4b but not into gap 6, is of metal, in particular gold.

Again, details of the used materials and design can be found in the section “general design and materials” below.

### Fourth Embodiment

In the fourth embodiment of FIG. 4, barrier 10 is again a multi-layer structure. It differs from the one of FIG. 3 in that there is a first surface section 14 of each electrode 4a, 4b that is only covered by the first cover layer 10a, a second surface section 16 of each electrode 4a, 4b that is only covered by the second cover layer 10b, and a third surface section 18 of each electrode 4a, 4b that is covered by both cover layers 10a, 10b.

This design has the advantage that the first and second sections 14, 16 can be optimized for their respective functions.

For example, the first cover layer 10a may be a dielectric cover layer, and the first section 14 is located in gap 8. The second cover layer 10b may be a conductive cover layer, in particular of gold, and the second surface section 16 may be located outside gap 8. This combination reduces the optical absorption in gap 6 while allowing to electrically contact the electrode (as shown below) in second section 16.

Again, details of the used materials and design can be found in the section “general design and materials” below.

### First Contact Design

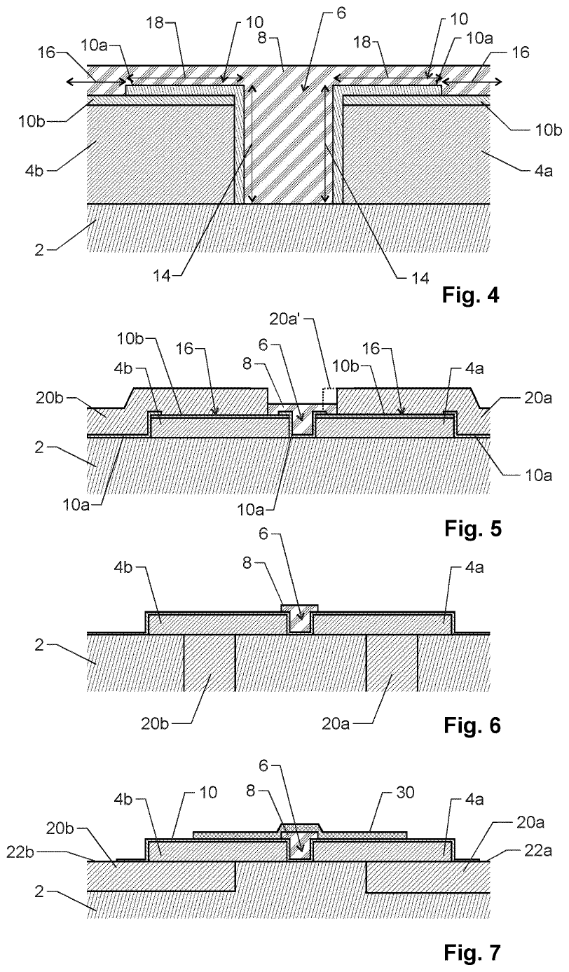

FIG. 5 shows a first sectional view along a plasmonic device perpendicular to the plasmonic waveguide. It shows the two electrodes 4a, 4b on substrate 2 and dielectric body 8 in gap 6 between the electrodes 4a, 4b. Barrier 10 is designed similar to the fourth embodiment of FIG. 4, i.e. with two cover layers 10a, 10b, each of which extends over only part of the upper and side surfaces of the electrodes 4a, 4b.

In particular, same as in FIG. 4, only first cover layer 10a extends into gap 8. In addition, there is a surface section 16 on the top of each electrode 4a, 4b that is only covered by second cover layer 10b.

In this embodiment, first cover layer 10a is of a dielectric (i.e. non-conductive) material while second cover layer 10b is of a conductive material, in particular gold.

FIG. 5 further shows a first conductive lead 20a and a second conductive lead 20b for contacting first and second electrode 4a, 4b, respectively. The conductive leads 20a, 20b may e.g. be of aluminum.

Each conductive lead 20a, 20b extends above at least part of its attributed electrode 4a, 4b and contacts second cover layer 10b at the surface section 16. Since second cover layer 10b is conductive, it electrically connects the respective electrode 4a, 4b to the conductive lead 20a, 20b above it.

In the shown embodiment, the conductive leads 20a, 20b do not cover all of surface section 16. Alternatively, they may cover all of surface section 16, as indicated by dotted lines 20a′ in FIG. 5 for conductive lead 20a.

### Second Contact Design

FIG. 6 shows a second design for contacting the electrodes 4a, 4b. In this embodiment, the conductive leads 20a, 20b contacting the electrodes 4a, 4b are formed by vias extending vertically through substrate 2. Thus, they can be contacted from the bottom side of substrate 2.

In this embodiment, barrier 10 may consist of a single, dielectric cover layer 10a extending over the upper and side surfaces of the electrodes 4a, 4b, thus protecting them from above. The bottom side of the electrodes 4a, 4b is protected by substrate 2. Alternatively, barrier 10 may also consist of several cover layers, but still it would advantageously protect the electrodes 4a, 4b along their top surfaces and side surfaces.

### Third Contact Design

FIG. 7 shows a third design for contacting the electrodes 4a, 4b. In this embodiment, the conductive leads 20a, 20b again contact the electrodes 4a, 4b from below. Here, however, the leads 20a, 20b are not designed as vias extending vertically through substrate 2. Rather, they extend along (i.e. parallel to) the top surface of substrate 2 and are exposed for being contacted at the location of contact pads 22a, 22b.

### Fourth Contact Design

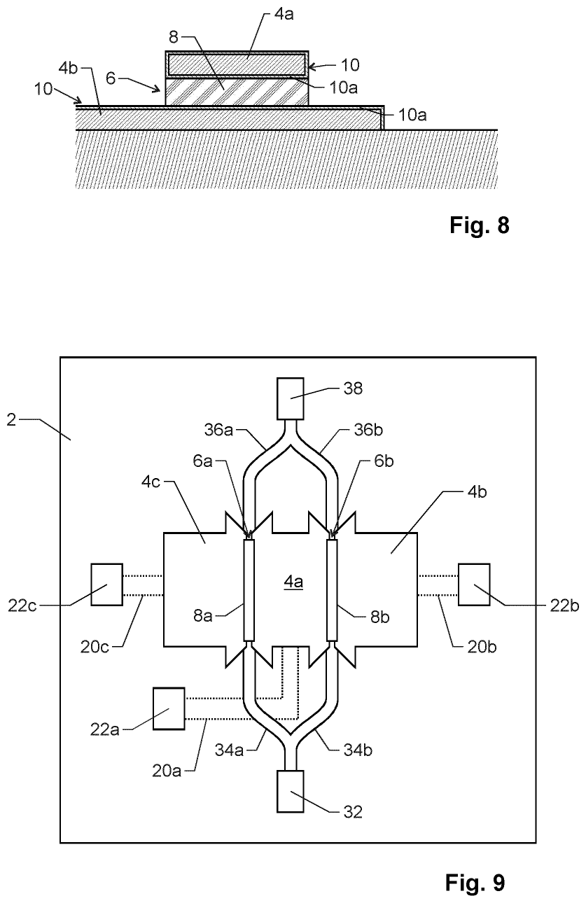

In the embodiments shown so far, the electrodes 4a, 4b are located horizontally beside each other on substrate 2. FIG. 8 shows a stacked design, where the electrodes 4a, 4b are located vertically above each other, with gap 6 arranged vertically between them.

Barrier 10 is located below and above dielectric body 8 to separate it fully from the electrodes 4a, 4b. It also encloses top electrode 4a from all sides to protect it, and it covers the top and vertical lateral sides of bottom electrode 4b.

In the shown example, barrier 10 e.g. consists of a single conductive cover layer 10a, which makes it possible to contact the electrodes 4a, 4b at any desired location. Alternatively, as described above, a combination of cover layers may be used, e.g. with dielectric cover layers only at the interface between the electrodes 4a, 4b and dielectric body 8 and with metal cover layers elsewhere.

### Protective Coating

In most of the embodiments described above and shown in the figures, dielectric body 8 is exposed to the environment at its upper surface. Alternatively, it may be covered by a protective coating 30 for protecting it from the environment. Such a protective coating is shown in FIG. 7, but it may be combined with any of the embodiments of the invention.

Protective coating 30 may e.g. be formed by an organic or inorganic dielectric. It also may fully cover all of barrier 10.

If dielectric body 6 is of an organic material, the protective coating is advantageously a material that can be deposited at low temperatures, such as a polymer film or lacquer. It may also be an ALD layer (i.e. be deposited by atomic layer deposition), a sputtered layer, an epoxy layer, a PVD (physical vapor deposition) layer, or a CVD (chemical vapor deposition) layer.

### Modulator Design

The plasmonic device may be used in a variety of applications, e.g. for light modulation, light detection, or electric field detection.

FIG. 9 shows a light modulator based on a symmetric interferometer arranged integrated on a substrate 2. The design comprises two plasmonic waveguides in two parallel gaps 6a, 6b and electro-optic dielectric bodies 8a, 8b. It has a central electrode 4a common to both waveguides and two separate, outer electrodes 4b, 4c for each of the waveguides.

Electrical leads 20a, 20b, 20c, e.g. of the type shown in FIG. 7, connect the electrodes 4a-4c to contact pads 22a-22c.

The device further comprises an incoupler 32 for coupling light into two non-plasmonic waveguides 34a, 34b, which carry the light to the plasmonic waveguides in the gaps 6a, 6b, respectively. From there, the light enters two more non-plasmonic waveguides 36a, 36b and is carried to an outcoupler 38 for coupling it out of the device.

### General Design and Materials

The following general aspects of the design and materials apply to all the embodiments of the current device.

As mentioned, barrier 10 may comprise a dielectric cover layer.

This dielectric cover layer may advantageously be of at least one of the following materials:
Titanium dioxide (TiO₂)
Silicon dioxide (SiO₂)
Silicon nitride (SiN)
Hafnium dioxide (HfO₂)
Aluminum Oxide (Al₂O₃)
Zirkonium dioxide (ZrO₂)

Among these materials, TiO₂ and/or HfO₂ is/are particularly advantageous because of their high refractive index and low absorption. If cooling is important, Al₂O₃ has good thermal conductivity.

Alternatively or in addition, barrier 10 may also comprise a conductive cover layer, which may advantageously be of at least one of the following materials:
Indium Tin Oxide (ITO): This is a moderately conductive material having low optical absorption.
Aluminum-doped Zinc Oxide (AZO): Again, this is a moderately conductive material having low optical absorption.
Platinum (Pt).
Gold (Au): Gold is advantageous in being a noble metal not prone to oxidation and well-suited to form gas-tight barrier layers. It can advantageously be used in combination with electrodes that are more prone to oxidation, such as silver or copper electrodes. Also, a thin cover layer of gold can improve plasmonic waveguiding.
Copper (cu): commonly used in CMOS compatible chip industry processes
Titanium (Ti): Ti shows a good adhesion to both metals and oxides
Silver (Ag): Using silver as a cover layer can reduce absorption, in particular in combination with electrodes that exhibit stronger absorption, such as gold electrodes. When silver is used as a cover layer, it is advantageously covered by a further cover layer, in particular a dielectric cover layer, to reduce the risk of oxidation.

Among these materials, gold is the most advantageous for its ability to form gas tight coatings that are chemically inert.

The electrodes 4a, 4b must be of a conductive material. They may advantageously be of one of the following materials:
Silver: For the reasons mentioned above (low absorption), this is the most advantageous material.
Copper: Copper has slightly higher optical losses than silver, but it is compatible with many standard semiconductor manufacturing processes. Copper also has poor compatibility with many electro-optic materials and is prone to oxidation, but barrier 10 allows to separate the copper from the electro-optic material, thereby reducing incompatibilities and/or oxidation.
Gold: non-oxidizing at relatively low loss.

Dielectric body 6 may be, as mentioned, an electro-optic material. Advantageously, it is a linear electro-optic material exhibiting the Pockels effect, in particular an organic material. In particular, it may be an amorphous material with polar linear electro-optical or second-order or third-order nonlinear optical molecules, and/or it may be a polymer with polar, linear electro-optic or second-order nonlinear optical side groups, where the polar molecules or side groups can be poled (i.e. at least partially aligned) in a process as described below. For example, the material may comprise an organic dye, organic crystals, organic electro-optic polymers, chromophores, composite materials, disperse red 1 (DR1), SEO100, SEO125, SEO250, GigOptix M3, JRD1, YLD124, HLD, AJCKL1, or any of the previous materials in a host material such as poly methyl methacrylate (PMMA), e.g. DR1 in PMMA or amorphous polycarbonate (APC), e.g. AJCKL1 in APC. The organic optical material may be a chromophore material.

Substrate 2 may be any suitable material for receiving the components above it, such as a glass or a semiconductor. Advantageously, it is provided with at least one coating layer of SiO₂ and, optionally, conducting structures, integrated at its top surface.

A preferred substrate is a silicon substrate with a dielectric layer, in particular of SiO₂, optionally with electric leads integrated thereon.

In a particularly advantageous combination of materials, the electrodes 4a, 4b are of silver combined with a cover layer of gold and/or of a dielectric and with an organic dielectric body.

The dimensions of gap 6 are chosen for good waveguiding, low absorption, strong light localization and high field strength.

The width W (see FIG. 1) of gap 6 is advantageously in the range of 50 -150 nm and its height H is in the range of 50 nm-300 nm.

### Method of Manufacture

The present device may e.g. be manufactured starting from substrate 2 and depositing structured material layers on top of it.

For example, when manufacturing the device of FIG. 7, starting from a semiconductor substrate, the leads 20a, 20b may be integrated as conducting layers of e.g. aluminum or copper. If the leads 20a, 20b are vias as in the example of FIG. 6, anisotropic etching is used for forming through-holes through substrate 2, whereupon a conductor is deposited in the through-holes.

Substrate 2 may be covered by a dielectric layer (not shown), in particular silicon oxide, but any leads 20a, 20b need to be exposed where they later are to contact the electrodes 4a, 4b.

The electrodes 4a, 4b may then be deposited, e.g. by e-beam evaporation, thermal evaporation, or sputtering from a silver target, and structured using masking and etching techniques.

Next, the cover layer(s) 10a, 10b can be deposited.

A dielectric cover layer may e.g. be deposited using ALD (atomic layer deposition), which provides a conformal coating. The deposited layer can then be structured using masking and etching techniques.

A metallic cover layer may e.g. be deposited using sputtering and, if the metal can be etched, using masking and etching techniques. If the metallic cover layer is gold, it is advantageously deposited using sputtering on the non-coated electrodes 4a, 4b. Since gold adheres to metal but not to dielectrics, in particular silicon oxide, it then can be removed easily (everywhere but from the electrodes) in a lift-off process, e.g. using acetone or sonication. Alternatively, one may use any other chemical treatment processes (such as self-assembled monolayers) to assure a selective deposition of the metal coating layer on the electrode while the substrate remains free of metal.

Then, dielectric body 8 is formed, e.g. by printing or by means of spin-coating subsequent to masking or followed by structuring.

Dielectric body 8 may then be poled in order to e.g. achieve linear electro-optic effects. This may be achieved by applying a voltage via the electrodes 4a, 4b, such as e.g. described in in section 2.3.4 and FIG. 2.3.8 of W. Heni, Plasmonic-Organic Hybrid Modulators, Dissertation ETH 25785 of the ETH Zürich, https://doi.org/10.3929/ethz-b-000353598.

Finally, if needed, protective coating 30 may be added, e.g. by a non-contact printing process or other thin film deposition techniques.

### Notes

In the embodiments above, the plasmonic waveguide is formed by the dielectric body 8 and both electrodes 4a, 4b. In an alternative embodiment, only one of the electrodes, in combination with the dielectric body, may form the plasmonic waveguide. The other electrode may e.g. be a semiconductor, or the barrier separating the dielectric body from the other electrode may be thick and have a low index of refraction to prevent efficient plasmon generation at that interface.

In the examples above, the dielectric material is an electro-optic material. It may also be an opto-electric material generating an electric field upon light irradiation, which allows to build a light detector. In yet another embodiment, the dielectric material may be a non-linear optical material, in which case the device may be used for frequency mixing or non-linear optical effects, such as frequency doubling. In yet another embodiment, the device may be used to assess other types of interactions between the plasmons and the dielectric body, e.g. for assessing intramolecular processes or charge transfer processes within the dielectric body.

While there are shown and described presently preferred embodiments of the invention, it is to be distinctly understood that the invention is not limited thereto but may be otherwise variously embodied and practiced within the scope of the following claims.

1. A plasmonic device comprising
a substrate,
at least two electrically conductive electrodes forming a gap between them,
at least one dielectric body arranged in the gap, with the dielectric body and at least one of the electrodes forming a plasmonic waveguide, and
a barrier) fully separating the electrodes and the dielectric body, wherein the barrier is of a material different from the electrodes and the dielectric body.

2. The plasmonic device of claim 1 wherein the electrodes are of silver or copper.

3. The plasmonic device of claim 1 claims wherein the dielectric body comprises an electro-optic material.

4. The plasmonic device of claim 1 wherein the barrier is formed by one or more cover layers.

5. The plasmonic device of claim 4 wherein at least one cover layer fully separates the dielectric body and the electrodes.

6. The plasmonic device of claim 4 wherein the barrier comprises at least two cover layers of different materials.

7. The plasmonic device of claim 6 wherein at least one cover layer extends only along part of an interface region between the dielectric body and the electrodes.

8. The plasmonic device of claim 6 wherein at least two cover layers fully separate the dielectric body and the electrodes.

9. The plasmonic device of claim 6 wherein the barrier has a first cover layer and a second cover layer wherein
in a first surface section of each electrode, only the first cover layer covers the electrode,
in a second surface section of each electrode, only the second cover layer covers the electrode, and
in a third surface section of each electrode, both the first and the second cover layers cover the electrode.

10. The plasmonic device of claim 9 wherein the first cover layer is a dielectric cover layer and the second cover layer is a conductive cover layer and wherein the first surface section is located in the gap and the second surface section is located outside the gap.

11. The plasmonic device of claim 4 wherein the barrier comprises at least one dielectric cover layer.

12. The plasmonic device of claim 11 wherein the dielectric cover layer is of at least one material of the group of Al₂O₃, ZrO₂, TiO₂, SiO₂, SiN, and HfO₂.

13. The plasmonic device of claim 4 comprising at least one conductive cover layer.

14. The plasmonic device of claim 13 wherein the conductive cover layer is of at least one material of the group of ITO, AZO, platinum, gold, copper, titanium, and silver.

15. The plasmonic device of claim 13
wherein the barrier comprises at least one dielectric cover layer and
wherein the conductive cover layer is closer to the electrodes than the dielectric cover layer.

16. The plasmonic device of claim 13 wherein the conductive layer is of metal and directly adjacent to the electrodes.

17. The plasmonic device of claim 1 wherein the barrier has a thickness of less than 20 nm.

18. The plasmonic device of claim 1 wherein said electrodes and said dielectric body are arranged in a vertical stack on said substrate.

19. The plasmonic device of claim 1 wherein said electrodes are arranged side by side on said substrate with the gap located horizontally between them.

20. The plasmonic device of claim 1 wherein at least one of the electrodes is completely covered by the barrier on its sides not facing the substrate.

21. The plasmonic device of claim 1 further comprising at least first conductive lead located in said substrate and contacting a first one of the electrodes from below.

22. The plasmonic device of claim 21,
wherein said electrodes are arranged side by side on said substrate with the gap located horizontally between them and
wherein the plasmonic device further comprises at least second conductive lead located in said substrate and contacting a second one of the electrodes from below.

23. The plasmonic device of claim 21 wherein said conductive lead or leads is a via or are vias extending through said substrate.

24. The plasmonic device of claim 21 wherein said conductive lead or leads extends or extend along a surface of the substrate but not through the substrate.

25. The plasmonic device of claim 1 further comprising at least a first conductive lead contacting a first one of the electrodes from above.

26. The plasmonic device of claim 25
wherein the barrier is formed by one or more cover layers,
wherein the plasmonic device comprises at least one conductive cover layer, and
wherein said first conductive lead contacts the first electrode via the conductive cover layer.

27. The plasmonic device of claim 25 comprising a first and a second conductive lead contacting the first and the second electrode, respectively, from above.

28. A method for manufacturing the plasmonic device of claim 1 comprising the step of depositing the electrodes, the barrier, and the dielectric body on the substrate.

29. The method of claim 28 comprising the steps of first depositing the electrodes, then the barrier and only then the dielectric body.

30. The method of any of claim 28 comprising the step of forming at least one conductive lead, prior to depositing the electrodes, wherein the conductive lead electrically contacts at least one of the electrodes.

31. The method of any of claim 28 comprising the step of forming at least one conductive lead, after depositing the electrodes, wherein the conductive lead electrically contacts at least one of the electrodes.

32. The method of any of claim 30, wherein the conductive lead is formed before depositing the dielectric body.

33. The plasmonic device of claim 1 wherein the dielectric body comprises an electro-optic organic material.

34. The plasmonic device of claim 7 wherein the at least one cover layer that extends only along part of the interface region between the dielectric body and the electrodes is of metal.

35. The plasmonic device of claim 7 wherein the at least one cover layer that extends only along part of the interface region between the dielectric body and the electrodes does not extend into the gap.
